(19) United States
(12) Patent Application Publication
(10) Pub. No.: US 2004/0060582 A1
(43) Pub. Date: Apr. 1, 2004

(54) Substrate processing apparatus

(75) Inventors: Tadashi Sasaki, Kyoto (JP); Kazuki Inoue, Kyoto (JP); Hideyuki Taniguchi, Kyoto (JP); Takeshi Yoshida, Kyoto (JP); Shigenori Kawakami, Kyoto (JP)

Correspondence Address: OSTROLENK FABER GERB & SOFFEN, 1180 AVENUE OF THE AMERICAS, NEW YORK, NY, 100368403

(73) Assignee: Dainippon Screen Mfg.Co., Ltd.

(21) Appl. No.: 10/666,766

(22) Filed: Sep. 17, 2003

(30) Foreign Application Priority Data
Sep. 18, 2002 (JP) 2002-271471

(51) Int. Cl. B08B 3/00

(52) U.S. Cl. 134/61

(57) ABSTRACT

A substrate processing apparatus is used to remove an organic matter attached to a substrate with use of a removal liquid. This apparatus includes a process chamber directed to an organic matter removal process, a holding element to hold the substrate in the process chamber, a removal liquid supply element to supply the removal liquid to the substrate held by the holding element, and a light-blocking element disposed in a transport path for the substrate that extends from a cassette housing the substrate and having high transparency, to the process chamber, thereby blocking light passing through the transport path into the process chamber.

### BACKGROUND OF THE INVENTION

1. Field of the Invention

The present invention relates to a substrate processing apparatus that removes with a removal liquid an organic matter remaining on a semiconductor substrate, a glass substrate for liquid crystal display, a glass substrate for photomask and a substrate for optical disk, etc. (hereinafter referred to simply as a “substrate”). Such an organic matter is, for example, polymer that is formed by subjecting a thin film existing on the substrate surface to dry etching by using a resist film as a mask.

2. Description of the Background Art

Copper is often used for wiring of high-technology devices. This is because copper has, for example, such a merit that it has a lower resistivity and does not tend to cause electromigration, as compared with aluminum conventionally employed. On the other hand, copper wiring requires difficult patterning technique and, at present, is generally formed by damascene method.

Damascene method includes the step of etching an interlayer insulation film (SiO₂ or low-k film) by using a resist film as a mask. Examples of this etching method are dry etchings such as RIE (reactive ion etching).

Since the power of reactive ions used in the above dry etching is extremely strong, the resist film is changed at a constant rate at the completion of the etching, and part of the resist film is changed to a reaction product such as polymer and then deposited on the sidewall of the interlayer insulation film. FIG. 11 illustrates the state that polymer formed by etching is adhered. An interlayer insulation film 201 and insulation film barrier layer 202 are alternately laminated on a copper lower wiring layer 203. A wiring part is formed by etching, and polymer 210 is deposited and adhered on the sidewall of the interlayer insulation film 201 located at the wiring part.

Since reaction products such as the polymer 210 cannot be removed in a subsequent resist removal step, it is necessary to remove this reaction product before or after the resist removal step. Conventionally, a reaction product removal process is performed before dry etching step or after resist removal step. In this removal process, the reaction product deposited on the sidewall of the interlayer insulation film is removed by supplying a removal liquid having the action to remove the reaction product. Thereafter, the substrate is washed with deionized water, followed by centrifugal drying of the deionized water.

However, there has been the possibility that when light enters from the exterior during the removal process using such removal liquid, the light acts as a catalyst and the copper lower wiring layer 203 is corroded. FIG. 12 illustrates the state that the copper lower wiring layer 203 is corroded during the removal process with use of the removal liquid. An occurrence of the portion of such corrosion can exert adverse effect on the copper wiring structure.

### SUMMARY OF THE INVENTION

According to a first aspect of the present invention, there is provided a substrate processing apparatus that removes an organic matter from a substrate with use of a removal liquid includes a process chamber, holding element, removal liquid supply element and light-blocking element. The process chamber is directed to an organic matter removal process. The holding element holds a substrate in the process chamber. The removal liquid supply element supplies the removal liquid to the substrate held by the holding element. The light-blocking element is disposed in a transport area for the substrate that extends from a cassette to the process chamber, thereby blocking light passing through the transport area into the process chamber. The cassette houses the substrate and allows at least partially for the transmission of light.

With this configuration, the inside of the process chamber can be made into a dark room by the presence of the light-blocking element. It is therefore possible to prevent any adverse effect caused by light acting as a catalyst during the organic matter removal process with use of a removal liquid.

In addition, when using a cassette allowing at least partially for the transmission of light, it is possible to reliably prevent the light passing through the cassette into the transport area for substrate in the apparatus from passing through the transport area into the process chamber during the organic matter removal process.

According to a second aspect of the present invention, in the substrate processing apparatus, the light-blocking element includes a plurality of light-blocking sections that are arranged in a plurality of locations in the transport area, respectively, and are capable of blocking light passing through the transport area into the process chamber. The clearance between the plurality of light-blocking sections is greater than the size of the substrate in the direction of transport of the substrate.

With this configuration, in the course of transporting a substrate in the transport area, at least one of the plurality of light-blocking sections arranged in a multistage can reliably be brought into a shut-off state, so that the inside of the process chamber is reliably made into a dark room.

According to a third aspect of the present invention, there is provided a substrate processing apparatus that removes an organic matter from a substrate with use of a removal liquid includes a process section, holding element, removal liquid supply element, indexer section, relay section and light-blocking element. The process section defines a light-blocking area enclosing a process chamber directed to an organic matter removal process. The holding element holds a substrate in the process chamber. The removal liquid supply element supplies the removal liquid to the substrate held by the holding element. The indexer section includes an indexer mechanism to load and unload the substrate with respect to a carrier set at a predetermined position. The relay section is disposed between the indexer section and the process section. The light-blocking element is disposed in a transport area for the substrate extending from the carrier to the process section, thereby blocking light passing through the transport area into the process section. The relay section includes a transfer mechanism to transfer the substrate between the indexer section and the process section. A first gate section to allow for the passage of the substrate is disposed between the indexer section and the relay section. A second gate section to allow for the passage of the substrate is disposed between the relay section and the process section. The light-blocking element includes a first light-blocking section disposed in the first gate section to thereby block light passing through the first gate section into the relay section; and a second light-blocking section disposed in the second gate section to thereby block light passing through the second gate section into the process section.

With this configuration, in the course of transporting a substrate between the carrier and process section, at least one of the first and second light-blocking sections can reliably be brought into a shut-off state, so that the inside of the process section is reliably made into a dark room.

In addition, the space for housing the facility of the apparatus can be increased by the amount of the installation of the relay section.

According to a fourth aspect of the present invention, there is provided a substrate processing apparatus that removes an organic matter from a substrate with use of a removal liquid includes a process section, holding element, removal liquid supply element, indexer section, relay section and light-blocking element. The process section encloses a process chamber directed to an organic matter removal process. The holding element holds a substrate in the process chamber. The removal liquid supply element supplies the removal liquid to the substrate held by the holding element. The indexer section includes an indexer mechanism to load and unload the substrate with respect to a carrier set at a predetermined position. The relay section is disposed between the indexer section and the process section. The light-blocking element is disposed in a transport area for the substrate extending from the carrier to the process section to thereby block light passing through the transport area into the process chamber. The relay section includes a transfer mechanism to transfer the substrate between the indexer section and the process section. The light-blocking element includes a first light-blocking section provided in a gate section which is disposed between the indexer section and the relay section so as to allow for the passage of the substrate, thereby blocking light passing through the gate section into the relay section; and a second light-blocking section provided in the process chamber which is disposed in an opening to allow for the passage of the substrate, to thereby block light passing through the opening into the process chamber.

With this configuration, in the course of transporting a substrate between the carrier and process chamber, at least one of the first and second light-blocking sections can reliably be brought into a shut-off state, so that the inside of the process chamber is reliably made into a dark room.

Accordingly, an object of the present invention is to provide a substrate processing apparatus capable of preventing adverse effect caused by light acting as a catalyst during the process of removing an organic matter with use of a removal liquid.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a substrate processing apparatus according to a first preferred embodiment of the present invention;

FIG. 2 is a diagram showing the configuration of a rotational process unit of the substrate processing apparatus in FIG. 1;

FIG. 3 is a diagram showing the configuration of a drying unit of the substrate processing apparatus in FIG. 1;

FIG. 4 is a diagram showing a planer configuration of a substrate processing apparatus according to a second preferred embodiment of the present invention;

FIG. 5 is a diagram showing a vertically sectional configuration of the substrate processing apparatus in FIG. 4;

FIG. 6 is a sectional view showing the configuration of a relay section and its surroundings of the substrate processing apparatus in FIG. 4;

FIG. 7 is a diagram showing the configuration of a shutter and its surroundings of the substrate processing apparatus in FIG. 4;

FIG. 8 is a sectional view of important parts in FIG. 7;

FIG. 9 is other sectional view showing the configuration of the relay section and its surroundings of the substrate processing apparatus in FIG. 4;

FIG. 10 is a diagram showing a modified form of the substrate processing apparatus in FIG. 4;

FIG. 11 is a diagram showing the state of adhesion of polymer formed by etching; and

FIG. 12 is a diagram showing the state that a copper lower wiring layer is corroded during a removal process with use of a removal liquid.

### DESCRIPTION OF THE PREFERRED EMBODIMENTS

### Definition of Terms

In the following preferred embodiments, the term “substrate” means a semiconductor substrate and, more particularly, a silicon substrate. The substrate includes a thin film. The thin film is a metal film or insulation film. Examples of the metal constituting the metal film are copper, aluminum, titanium, tungsten, and a mixture of these. Examples of the insulation film are oxide films and nitride films of the above-mentioned metals, silicon oxide film, silicon nitride film, organic insulation film and low dielectric interlayer insulation film. The term “thin film” used herein means one that in a vertical cross section with respect to a substrate with a thin film formed thereon, its height dimension is shorter than its bottom length, as well as one in which its height dimension is longer than its bottom length. Therefore, included in such thin film is also one that exists in the shape of a line or island when a substrate is viewed from a direction perpendicular to the main surface of the substrate, such as a film or wiring partially formed on the substrate.

On a substrate after passing through the step in which such thin film is subjected to dry etching using a patterned resist mask as a mask, polymer that is a reaction product derived from the resist and thin film is formed by the dry etching.

The term “substrate processing” used in the following preferred embodiments means a polymer removal process for removing polymer from a substrate with the polymer formed thereon.

In the following description, polymer separated from a substrate is expressed as “contaminant” in some cases.

The term “removal liquid” used in the following preferred embodiments means a polymer removal liquid. The polymer removal liquid selectively removes polymer alone. For example, there are organic amine removal liquids containing organic amine such as dimethyl sulfoxide and dimethyl formamide; ammon fluoride removal liquids containing ammon fluoride; and inorganic removal liquids.

Examples of the organic amine removal liquids are a mixed solution of monoethanolamine, water and aromatic triol; a mixed solution of 2-(2-aminoethoxy)ethanol, hydroxyamine and catechol; a mixed solution of alkanolamine, water, dialkyl sulfoxide, hydroxyamine and amine anticorrosive; a mixed solution of alkanolamine, glycol ether and water; a mixed solution of dimethyl sulfoxide, hydroxyamine, triethylenetetramine, pyrocatechol and water; a mixed solution of water, hydroxyamine and pyrogallol; a mixed solution of 2-aminoethanol, ethers and sugar alcohols; and a mixed solution of 2-(2-aminoethoxy) ethanol, N-dimethylacetoacetamide, water and triethanolamine.

Examples of the ammon fluoride removal liquids are a mixed solution of organic alkali, sugar alcohol and water; a mixed solution of fluorochemical, organic carboxylic acid and acid amide solvent; a mixed solution of alkylamide, water and ammon fluoride; a mixed solution of alkylamide, water and anmony fluoride; a mixed solution of dimethyl sulfoxide, 2-aminoethanol, organic alkali solution and aromatic hydrocarbon; a mixed solution of dimethyl sulfoxide, anmony fluoride and water; a mixed solution of ammon fluoride, triethanolamine, pentamethyldiethylenetriammine, iminodiacetic acid and water; a mixed solution of glycol, alkyl sulfate, organic salt, organic acid and inorganic salt; a mixed solution of amide, organic salt, organic acid and inorganic salt; and a mixed solution of amide, organic salt, organic acid and inorganic salt.

Example of the inorganic removal liquid is a mixed solution of water and phosphate derivative.

The term “organic solvent” means a hydrophilic organic solvent, i.e., water-soluble organic solvent. Specifically, this solvent can be mixed with water and can decrease the boiling point of the mixture. Here, it is possible to use ketones such as acetone and diethylketone; ethers such as methyl ether and ethyl ether; and polyhydric alcohol such as ethylene glycol. Taking into consideration that those which contain less amount of contaminant, such as metal, have been widespread in the market, it is most desirable to use isopropyl alcohol (IPA). The following preferred embodiments therefore employ IPA.

### First Preferred Embodiment

1. Overall Configuration

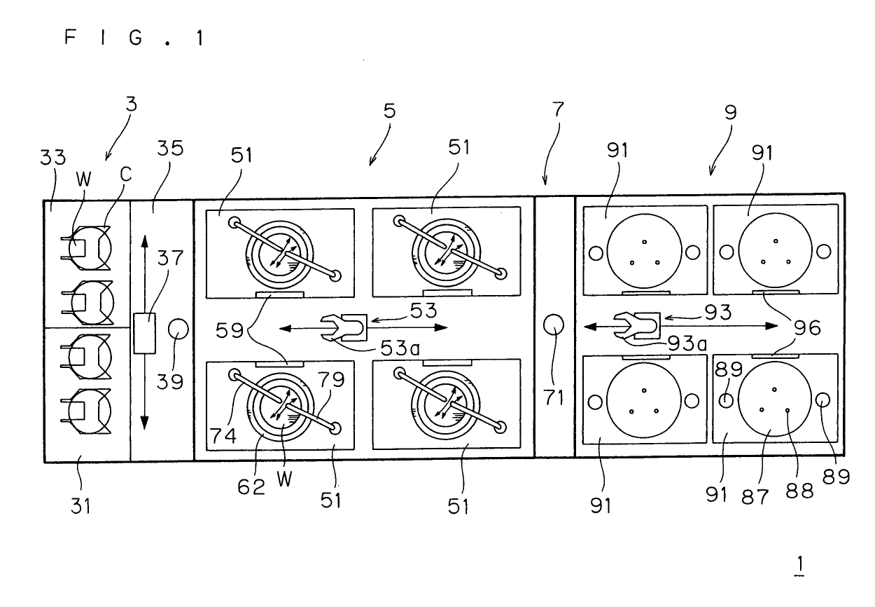

FIG. 1 is a plan view of a substrate processing apparatus 1 according to a first preferred embodiment of the present invention. The apparatus 1 includes an indexer section 3, a rotational process section 5, an interface 7 and a drying process section 9, which are aligned in a row.

The indexer section 3 includes a loading section 31 on which a carrier C encasing an untreated substrate W is mounted, an unloading section 33 on which a carrier C encasing a treated substrate W is mounted, and a transfer section 35.

The loading section 31 includes a mounting table and two carriers C are loaded therein by a transport mechanism disposed outside the apparatus. The carrier C holds, for example, 25 substrates W in such a state that they are in their horizontal position and arranged at vertically spaced intervals. The unloading section 33 also includes a mounting table, and two carriers C are mounted on the mounting table. The two carriers C are unloaded by a transport mechanism disposed outside the apparatus.

The transfer section 35 includes a first transfer table 39 and an indexer mechanism 37 that moves in the direction of alignment of the carriers C of the loading section 31 and unloading section 33, and also loads and unloads a substrates W with respect to the carriers C. The indexer mechanism 37 includes an indexer arm (not shown). Therefore, in addition to movement in a horizontal direction, the indexer mechanism 37 can perform rotational motion around a vertical direction, and a lifting and lowering motions in the vertical direction, as well as advance and retraction motions of the indexer arm. By these motions, the indexer mechanism 37 loads and unloads the substrate W with respect to the carriers C, and also gives and receives the substrate W with respect to the first transfer table 39.

The rotational process section 5 is disposed adjacent to the indexer section 3 and includes four rotational process units 51 and a first substrate transport mechanism 53. Each rotational process unit 51 encases a substrate W to thereby perform removal process of a reaction product. The first substrate transport mechanism 53 gives and receives a substrate W with respect to the first and second transfer tables 39 and 71, and it also gives and receives a substrate W with respect to the four rotational process units 51.

A row of the rotational process units 51 is formed by aligning two rotational process units 51 in a direction orthogonal to the direction of alignment of the carriers C of the indexer section 3. Two rows of the rotational process units 51 are disposed apart in the direction of alignment of the carriers C. The first substrate transport mechanism 53 is disposed between the rows of the rotational process units 51. The rotational process unit 51 will be hereinafter described in detail.

The first substrate transport mechanism 53 includes a transport arm 53a and can perform movement in a horizontal direction, rotational motion around a vertical direction, and lifting and lowering motions in the vertical direction, as well as advance and retraction motions of the transport arm 53a. By these motions, the first substrate transport mechanism 53 travels along space between the rows of the rotational process units 51 to thereby give and receive a substrate W with respect to each rotational process unit 51, and give and receive a substrate W with respect to the first transfer table 39. The first substrate transport mechanism 53 also gives and receives a substrate W with respect to a second transfer table 71 to be described later.

The interface 7 is interposed between the rotational process section 5 and drying process section 9 and includes the second transfer table 71 for mounting a substrate W.

The drying process section 9 is disposed adjacent to the interface 7 and includes four drying units 91 and a second substrate transport mechanism 93. Each drying unit 91 encases a substrate W to thereby perform drying. The second substrate transport mechanism 93 gives and receives a substrate W with respect to the second transfer table 71, as well as the four drying units 91.

A row of the drying units 91 is formed by aligning two drying units 91 in a direction orthogonal to the direction of alignment of the carriers C of the indexer section 3. Two rows of the drying units 91 are disposed apart in a direction of alignment of the carriers C. The second substrate transport mechanism 93 is disposed in space between the rows of the drying units 91. The drying unit 91 will hereinafter be described in detail.

The second substrate transport mechanism 93 includes a transport arm 93a and can perform movement in a horizontal direction, rotational motion around a vertical direction, and lifting and lowering motions in the vertical direction, as well as advance and retraction motions of the transport arm 93a. By these motions, the second substrate transport mechanism 93 travels along space between the drying units 91 to thereby give and receive a substrate W with respect to each drying unit 91, as well as the second transfer table 71.

2. Rotational Process Unit

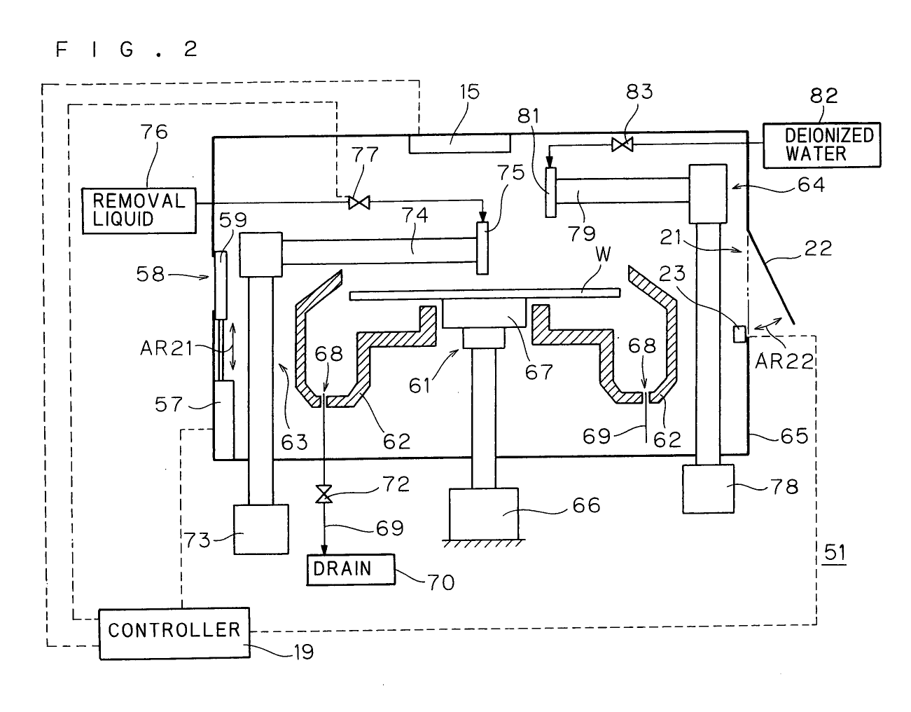

The rotational process unit 51 will be further described by referring to FIG. 2, which is a diagram showing the configuration of the rotational process unit 51.

The rotational process unit 51 includes a substrate holding element 61 that rotates while holding a single substrate W in a horizontal position, a cup 62 surrounding the periphery of the held substrate W, a removal liquid supply element 63 for supplying a removal liquid to the held substrate W, a deionized water supply element 64 for supplying deionized water to the held substrate W, and a chamber 65 for encasing the substrate W held by the substrate holding element 61. The rotational process unit 51 also includes a shutter 59 for blocking light passing through a transfer opening 58 through which a substrate is loaded and unloaded with respect to the chamber 65, and a lamp 15 for illuminating the inside of the chamber 65, and a viewing window 21 through which the inside of the chamber 65 is viewed. The cup 62 moves up and down by a mechanism (not shown).

The chamber 65 is a process chamber in which a substrate W is encased to perform removal process of reaction products. The chamber 65 is composed of such a light-blocking material that does not transmit light. Disposed in a sidewall of the chamber 65 (the sidewall on the side of the first substrate transport mechanism 53) is the transfer opening 58 through which a substrate W is loaded and unloaded with respect to the chamber 65. The chamber 65 is always under normal pressure. The atmosphere of the chamber 65 is discharged by a discharge mechanism (not shown) to a predetermined exhaust duct that is disposed outside the apparatus. This avoids that the atmosphere containing the mist and vapor of processing liquid leaks from the chamber 65.

A shutter 59 is provided in the chamber 65. The shutter 59 can be lifted and lowered by a shutter opening and closing mechanism 57, as indicated by a double-headed arrow AR21 in FIG. 2. During the time that the shutter opening and closing mechanism 57 lifts the shutter 59, the shutter 59 closes the transfer opening 58. The shutter 59 is also composed of a light-blocking material that does not transmit light. During the time that the shutter 59 closes the transfer opening 58, it is possible to block the light passing through the transfer opening 58 to the inside of the chamber 65. On the other hand, during the time that the shutter opening and closing mechanism 57 lowers the shutter 59, the transfer opening 58 is opened. During the time that the transfer opening 58 is opened, a substrate W can be loaded into or unloaded from the chamber 65 through the transfer opening 58 by the first substrate transport mechanism 53. As will be described later, at least during the time that a reaction product is removed by a removal liquid, the shutter 59 closes the transfer opening 58.

The substrate holding element 61 includes a motor 66 disposed outside the chamber 65, and a chuck 67 that is driven by the motor 66 so as to rotate around a vertically oriented axis.

Although the substrate holding element 61 is disposed in the chamber 65, the pressure in the chamber 65 is not reduced. In the substrate processing apparatus 1, it is configured to reduce the pressure of the inside of a sealed chamber 86 described later, and therefore to dispose the substrate holding element 61 outside the sealed chamber 86.

The cup 62 is of an approximately doughnut-type when viewed from above, and includes a centrally located opening through which the chuck 67 can pass. The cup 62 collects liquid scattering from a substrate W in rotation (e.g., the removal liquid and deionized water) and also discharges the collected liquid from a drainage port 68 disposed in a lower part of the cup 62. The drainage port 68 is connected in communication with a drain pipe 69 in communication with a drain 70. A drain valve 72 for opening and closing a duct line of the drain pipe 69 is provided in the course of the drain pipe 69. The liquid can be exhausted through the drainage port 68 to the drain 70 by opening the drain valve 72.

The removal liquid supply element 63 includes a motor 73 disposed outside the chamber 65, an arm 74 that is rotated by the motor 73, a removal liquid nozzle 75 that is disposed at the tip of the arm 74 and discharges the removal liquid downwardly, and a removal liquid source 76 to supply the removal liquid to the removal liquid nozzle 75. The removal liquid nozzle 75 is connected in communication with the removal liquid source 76 by a duct line in which a removal liquid valve 77 is provided. There is lifting and lowering element (not shown), which lifts and lowers the removal liquid nozzle 75 by lifting and lowering the motor 73.

By motivating the motor 73, the removal liquid nozzle 75 moves reciprocally between its discharge position above the center of rotation of the substrate W and its standby position located at the exterior of the cup 62 (see FIG. 1).

The deionized water supply element 64 includes a motor 78 disposed outside the chamber 65, an arm 79 that is rotated by the motor 78, a deionized water nozzle 81 that is disposed at the tip of the arm 79 and discharges deionized water downwardly, and a deionized water source 82 to supply deionized water to the deionized water nozzle 81. The deionized water nozzle 81 is connected in communication with the deionized water source 82 by a duct line in which a deionized water valve 83 is provided. There is lifting and lowering element (not shown), which lifts and lowers the deionized water nozzle 81 by lifting and lowering the motor 78.

By motivating the motor 78, the deionized water nozzle 81 moves reciprocally between its discharge position above the center of rotation of the substrate W and its standby position located at the exterior of the cup 62.

The viewing window 21 for viewing the inside of the chamber 65 is provided in a sidewall of the chamber 65 (the sidewall on the opposite side of the first substrate transport mechanism 53). A viewing door 22 for opening and closing the viewing window 21 is also provided in the chamber 65. The viewing door 22 can be opened and closed as indicated by a double-headed arrow AR22 in FIG. 2. When the viewing door 22 is in a solid line in the figure, the viewing window 21 is opened. When it is in a dash-double-dot line, the viewing window 21 is closed. The viewing door 22 is also composed of such a light-blocking material that does not transmit light. When the viewing door 22 closes the viewing window 21, it is possible to block the light passing through the viewing window 21 to the inside of the chamber 65.

On the other hand, when the viewing door 22 opens the viewing window 21, an operator can view the inside of the chamber 65 through the viewing window 21. The chamber 65 is provided with a locking and unlocking mechanism 23 that has the function of fixing the viewing door 22 at the dash-double-dot line in FIG. 2 when the viewing window 21 is closed, namely the function of prohibiting the opening of the viewing window 21. Concretely, if the viewing window 22 is made of stainless steel, electromagnet may be operated to prohibit the opening of the viewing window 21. Alternatively, the locking and unlocking mechanism 23 may be configured so as to mechanically prohibit the opening of the viewing window 21.

The locking and unlocking mechanism 23 contains an optical sensor to detect the opening and closing of the viewing window 21.

A lamp 15 for illuminating the inside of the chamber 65 is provided in a ceiling portion on the inside of the chamber 65. By opening the viewing window 21 with the lamp 15 lighting up, the operator can view the inside of the chamber 65 through the viewing window 21. For example, it is possible to confirm whether a removal liquid is discharged precisely from the removal liquid nozzle 75 to the rotational center of a substrate W.

The rotational process unit 51 further includes a controller 19 disposed outside the chamber 65. The controller 19 is electrically connected to at least the shutter opening and closing mechanism 57, lamp 15, locking and unlocking mechanism 23 and removal liquid valve 77 to thereby control their respective operations. Its concrete control manner will be fully described later. In an alternative, the controller 19 may control the motors 66, 73 and 78 so as to manage the entire operation of the rotational process unit 51.

3. Drying Unit

FIG. 3 is a diagram showing the configuration of a drying unit 91. The drying unit 91 includes a sealed chamber 86 that is airtight and disposed above a frame 85, a temperature control plate 87 including a temperature control function, an upper part of which is located in the sealed chamber 86, a pressure reduction element 90 for reducing the pressure within the sealed chamber 86, an atmospheric pressure release element 40 for returning the reduced pressure within the sealed chamber 86 to atmospheric pressure, and a solvent vapor supply element 80 for supplying an organic solvent vapor into the sealed chamber 86. The pressure reduction element 90 includes a pump 84 and a duct line to provide communication between the pump 84 and the sealed chamber 86.

A shutter 96 is disposed in the sealed chamber 86. The shutter 96 is opened when a substrate W is loaded in or unloaded from the sealed chamber 86 by the second substrate transport mechanism 93, and the shutter 96 is closed in other times to thereby maintain gastightness of the sealed chamber 86. An exhaust port 89 is disposed at a lower part of the sealed chamber 86, and it is connected to the pump 84 through a duct line. The pump 84 reduces the pressure within the sealed chamber 86 by exhausting the atmosphere of the sealed chamber 86.

The temperature control plate 87 projects in the sealed chamber 86. The temperature control plate 87 includes in its inside a heating or cooling mechanism for controlling the temperature of a substrate W. The temperature control plate 87 includes three pins 88 on which the substrate W is to be placed. These pins 88 are ascended when the substrate W is given to and received from the second substrate transport mechanism 93, and they are descended when the substrate W is subjected to drying process. When the pins 88 are descended to perform drying process, the top of the pins 88 slightly projects from the top surface of the temperature control plate 87, thereby leaving a slight gap between the substrate W and the temperature control plate 87.

The solvent vapor supply element 80 includes a solvent vapor supply nozzle 92 for supplying a solvent vapor (IPA (isopropyl alcohol) is used here) into the sealed chamber 86, a solvent vapor source 95 from which a solvent vapor is sent to the solvent vapor supply nozzle 92, and a solvent valve 94 disposed in a solvent duct line 97 connecting in communication between the solvent vapor source 95 and solvent vapor supply nozzle 92. The term “solvent vapor” means mist organic solvent composed of fine droplets and gaseous organic solvent. Therefore, the solvent vapor source 95 contains, as solvent vapor generating element, (i) an ultrasonic vaporization element that obtains solvent vapor by applying ultrasonic wave to liquid IPA; (ii) a heat vaporization element that obtains solvent vapor by heating liquid IPA; and (iii) a bubbling vaporization element that obtains solvent vapor by passing bubbles of inert gas (e.g., nitrogen) through liquid IPA.

A gas duct line 98 extending from an N₂ source 99 that is a supply source of inert gas (nitrogen gas is used here) is connected in communication with the sealed chamber 86. A gas valve 93 for opening and closing the passage of the gas duct line 98 is disposed in the course of the gas duct line 98. The atmospheric pressure release element 40 for returning the reduced pressure within the sealed chamber 86 to atmospheric pressure includes the gas duct line 98, gas valve 93 and N₂ source 99.

4. Contents of Process

The following is a substrate processing method by use of the above-mentioned substrate processing apparatus 1. This method comprises a removal liquid supply step, deionized water supply step, spin-dry step and drying step as follows.

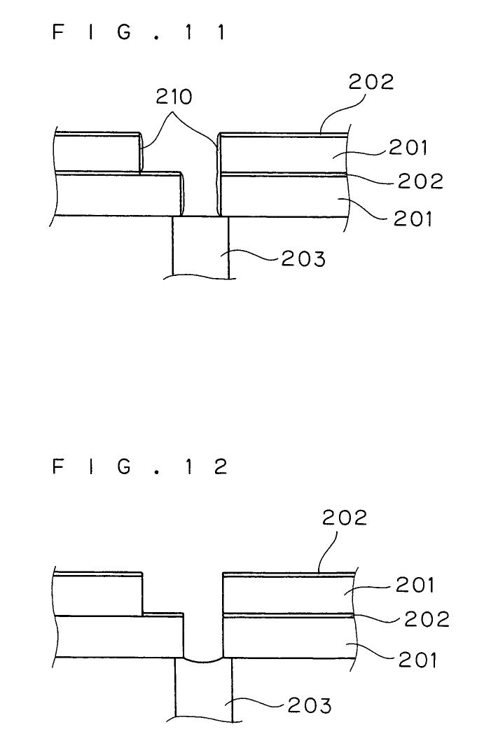

First, a substrate W encased in the carrier C is loaded in the loading section 31. The substrate W includes a thin film, and this film is already subjected to dry etching by using a patterned resist film as a mask. Therefore, a reaction product (polymer), which is derived from the resist film and thin film, is attached to the substrate W (see FIG. 11).

By the indexer mechanism 37, a single substrate W is taken out of the carrier C of the loading section 31 and placed on the first transfer table 39. By the first substrate transport mechanism 53, the substrate W placed on the first transfer table 39 is taken out and then loaded in a predetermined one of the four rotational process units 51. In the rotational process unit 51, the shutter 59 is lowered to open the transfer opening 58, so that the substrate W transported by the first substrate transport mechanism 53 is received and held by the chuck 67. In the rotational process unit 51 that has received the substrate W, the substrate holding element 61 holds the substrate W. The drain valve 72 is opened.

The substrate holding element 61 rotates the motor 66 to thereby rotate the substrate W. After the substrate W turns a predetermined number of revolutions, the removal liquid supply step is initiated. In this step, the motor 73 rotates so that the removal liquid nozzle 75 in its standby position moves to its discharge position. The removal liquid valve 77 is then opened so that a removal liquid is supplied from the removal liquid nozzle 75 to the substrate W. The removal liquid supplied to the substrate W falls down to the outside of the substrate W. This removal liquid is collected by the cup 62 and discharged via the drain pipe 69 to the drain 70. After the removal liquid is supplied for a predetermined period of time, the removal liquid valve 77 is closed and the removal liquid nozzle 75 is returned to its standby position.

In this removal liquid supply step, the removal liquid supplied to the substrate W is reactive to a reaction product on the substrate W, thus facilitating the separation of this reaction product from the substrate W. Accordingly, the reaction product is gradually removed from the substrate W by rotation of the substrate W and the supply of the removal liquid.

Also in the removal liquid supply step, at least during the reaction product removal process with the removal liquid, the controller 19 controls the shutter opening and closing mechanism 57 so that the shutter 59 closes the transfer opening 58, and it turns off the lamp 15. Further, at least during the reaction product removal process with the removal liquid, the controller 19 controls the locking and unlocking mechanism 23 so as to establish interlock of prohibiting the opening of the viewing window 21. Accordingly, at least during the time that the reaction product on the substrate W is removed with the removal liquid, the shutter 59 performs light blocking of the transfer opening 58, as well as the viewing window 21 so that the inside of the chamber 65 is made into a dark room.

This allows the substrate processing apparatus 1 to prevent any adverse effect caused by light acting as a catalyst during the reaction product removal process with the removal liquid.

In addition, since there is established the interlock of prohibiting the opening of the viewing window 21 at least during the reaction product removal process with the removal liquid, the viewing window 21 cannot be opened if an operator carelessly attempts to open the viewing window 21. This enables to maintain light blocking of the chamber 65, thus reliably preventing any adverse effect to be caused by light acting as a catalyst.

In contrast, at least during the time that the viewing window 21 is opened, it is so configured as to prohibit the removal liquid supply to a substrate W. Concretely, during the time that the controller 19 receives from the locking and unlocking mechanism 23 a signal indicating that the mechanism 23 has detected the opening of the viewing window 21, the controller 19 closes the removal liquid valve 77 and establishes interlock of prohibiting the removal liquid supply from the removal liquid nozzle 75. Thus, there is no possibility of executing the removal process under the circumstances that the viewing window 21 is opened and light enters the chamber 65. This enables to prevent any adverse effect to be caused by light acting as a catalyst during the removal process.

Likewise, at least during the time that the lamp 15 lights up, it is so configured as to prohibit the removal liquid supply to a substrate W. Concretely, during the time that the lamp 15 lights up, the controller 19 closes the removal liquid valve 77 and establishes interlock of prohibiting the removal liquid supply from the removal liquid nozzle 75. Thus, there is no possibility of executing the removal process under the circumstances that the lamp 15 lights up and the inside of the chamber 65 is illuminated. This enables to prevent any adverse effect to be caused by light acting as a catalyst during the removal process.

Furthermore, it is configured such that the opening and closing of the viewing window 21 is operative relation with lighting up and lighting out of the lamp 15. That is, the viewing window 21 is provided in order that an operator views the inside of the chamber 65 at the time of dummy running, etc. When the viewing window 21 is opened, it is necessary to illuminate the inside of the chamber 65 in order to make it visible. In contrast, when the viewing window 21 is closed, no illumination of the inside of the chamber 65 is required. In particular, illumination should not be done during the reaction product removal process. Therefore, when the viewing window 21 is opened, the controller 19 controls such that the lamp 15 lights up (active state), whereas when it is closed, the controller 19 controls such that the lamp 15 lights out (inactive state).

Subsequently, the deionized water supply step is executed. In this step, the motor 78 rotates to move the deionized water nozzle 81 in its standby position to its discharge position. Then, the deionized water valve 83 is opened to supply deionized water from the nozzle 81 to the substrate W. The deionized water supplied to the substrate W runs down to the outside of the substrate W and collected by the cup 62 and exhausted to the drain 70 through the drain pipe 69. After deionized water is supplied for a predetermined period of time, the deionized water valve 83 is closed and the deionized water nozzle 81 is returned to the standby position.

In this deionized water supply step, the substrate W is washed free from contaminants, such as the removal liquid and dissolved reaction product, with the deionized water supplied to the substrate W.

Subsequently, the spin-dry step is performed. In this step, the substrate W is rotated at high speed so as to spin out the liquid on the substrate W. Thereby the substrate W is almost dried.

When the treatment in the rotational process unit 51 is completed, the shutter 59 is lowered to open the transfer opening 58, and the first substrate transport mechanism 53 unloads the substrate W and places it on the second transfer table 71. The second substrate transport mechanism 93 takes this substrate W out of the second transfer table 71 and loads it in one of the drying units 91. In the drying unit 91, the shutter 96 is opened, and the second substrate transport mechanism 93 places the substrate W on the raised pins 88. The shutter 96 is then closed to maintain gastightness of the sealed chamber 86.

Subsequently, drying process is performed in the drying unit 91. This drying process is executed through a sequence of drying processes including temperature control step, substitution step, pressure reduction step, gas supply step, solvent supply step, and atmospheric pressure release step, which are descried later.

First, the temperature control plate 87 is kept at a dry temperature before the substrate W is loaded in the sealed chamber 86. The term “dry temperature” means a temperature below the ignition point of an organic solvent. Hereat, the temperature control plate 87 is set at a temperature of not less than 30° C. to not more than 40° C., taking into consideration that IPA is used as the organic solvent. A reduction in throughput is avoidable because before loading the substrate W, the temperature of the temperature control plate 87 is controlled to maintain a predetermined temperature.

Then, the pins 88 are lowered such that the substrate W is brought near the temperature control plate 87, and the temperature control step of heating the substrate W is executed.

After the shutter 96 is closed, the pump 84 is driven to exhaust the atmosphere of the sealed chamber 86, whereas the gas valve 93 is opened to admit nitrogen gas into the sealed chamber 86. This effects the substitution step of substituting the atmosphere of the sealed chamber 86 with nitrogenous atmosphere.

Subsequently, during continued drive of the pump 84, the gas valve 93 is closed to stop the nitrogen gas supply to the sealed chamber 86, thereby reducing the pressure in the sealed chamber 86. This effects the pressure reduction step of lowering the atmospheric pressure of the sealed chamber 86 than atmospheric pressure (101325 Pa). Here the pressure in the sealed chamber 86 is reduced to 666.5 Pa to 6665 Pa, preferably 666.5 Pa to 2666 Pa.

In addition, after closing the gas valve 93, the solvent valve 94 is opened during continued drive of the pump 84. This causes the solvent supply step of supplying the organic solvent from the solvent vapor nozzle 92 to the sealed chamber 86. After the solvent valve 94 is opened for a predetermined period of time, the solvent valve 94 is closed.

After closing the solvent valve 94, the gas valve 93 is opened again during continued drive of the pump 84. This causes the atmospheric pressure release step of returning the pressure in the sealed chamber 86 to the atmospheric pressure. After an elapse of a predetermined time, the drive of the pump 84 is stopped with the gas valve 93 opened. Thereafter, the gas valve 93 is closed and the drying process is terminated.

Since the substrate W is heated in the temperature control step, the water remaining on the substrate W is easy to evaporate. In addition, the atmospheric pressure around the substrate W is lowered in the pressure reduction step. As the result, the boiling point of liquid is lowered to thereby further facilitate evaporation of the deionized water remaining on the substrate W.

Furthermore, the organic solvent vapor is supplied to the substrate W in the pressure reduction step. Thereby, the organic solvent is mixed with the water remaining on the substrate W. Since a mixture of the water and organic solvent has a lower boiling point than water, this mixture on the substrate W can evaporate easily thus to eliminate the water from the substrate W. In addition to this, since its boiling point is lowered because of a reduction in the atmospheric pressure around the substrate W, the mixture of the water and the organic solvent evaporates easily in a short period of time. It is therefore possible to dry the substrate W in a considerably reliable manner.

In an alternative, the drying step may be executed by the pressure reduction step, solvent supply step and atmospheric pressure release step. In this case, due to a reduction in the atmospheric pressure around the substrate W, the boiling point of the water remaining on the substrate W is lowered, and the water evaporates easily to thereby effect the drying process.

In other alternative, the drying step may be executed by the pressure reduction step, solvent supply step and atmospheric pressure release step. Although a mixture of the water on the substrate W and the organic solvent is formed in this case, this mixture evaporates easily because it has a lower boiling point than water. In addition to this, since the boiling point is lowered due to a reduction in atmospheric pressure around the substrate W, the water can be evaporated reliably for a shorter period of time.

In other alternative, the drying step may be executed by the pressure reduction step, temperature control step and atmospheric pressure release step. In this case, the water on the substrate W is heated in the temperature control step and the surrounding atmospheric pressure is lowered, so that this water evaporates reliably in a short period of time.

In other alternative, the drying step may be executed only by the solvent supply step. Although a mixture of the water on the substrate W and the organic solvent is formed in this case, this mixture evaporates easily because it has a lower boiling point than water. Therefore, the substrate W can be dried reliably in a short period of time.

In other alternative, the drying step may be executed by the temperature control step and the solvent supply step. Although a mixture of the water on the substrate W and the organic solvent is formed in this case, this mixture evaporates easily because it has a lower boiling point than water. In addition to this, since this mixture is heated in the temperature control step, it easily reaches its boiling point and evaporates. This enables to reliably dry the substrate W in a short period of time.

At the completion of the drying process in the drying unit 91, the substrate process is entirely completed, and the treated substrate W is then transported to the unloading section 33.

First, the pins 88 of the drying unit 91 are lifted and the shutter 96 is opened. Then, the second substrate transport mechanism 93 unloads the substrate W from the drying unit 91 and then places it on the second transfer table 71.

Subsequently, the first substrate transport mechanism 53 takes the substrate W on the second transfer table 71 and then places it on the first transfer table 39. By the indexer mechanism 37, the substrate W placed on the first transfer table 39 is taken out and loaded in the carrier C placed on the loading section 33.

In an alternative, the first transfer table 39 and the second transfer table 71 may be constructed by a plurality of substrate mounting element, such as a multistage table. In this case, a treated substrate W and untreated substrate W can coexist in the interface 7, thereby avoiding a drop in throughput.

5. Modifications of First Preferred Embodiment

It should be understood that the present invention is not limited to the examples shown in the foregoing preferred embodiment. As an example, the foregoing preferred embodiment discloses to remove, from a substrate passing through the dry etching step in which a thin film present on the substrate surface is subjected to dry etching by using a resist film as a mask, polymer that is a reaction product formed during the dry etching. The present invention is however not limited to the case where polymer to be formed during dry etching and present on a substrate is removed from the substrate.

For instance, the present invention is applicable to the case where polymer to be formed during plasma ashing is removed from a substrate. That is, the present invention is applicable to the case of removing from a substrate polymer formed by resist in a variety of processes that are not necessarily limited to dry etching.

The present invention is not limited to the case of removing polymer alone that is formed by dry etching or plasma ashing process, but is applicable to the case where a variety of reaction products derived from a resist are removed from a substrate.

Further, the present invention is not limited to the case where a reaction product derived from a resist is removed from a substrate, but is applicable to the case of removing a resist itself from a substrate.

For instance, the present invention is applicable to the case of removing, from a substrate after being subjected to the following steps of: applying a resist; exposing a wiring pattern etc. on the resist; developing the resist; and performing underlayer process to a layer underlying the resist (e.g., etching to a thin film as an underlayer), the resist film that becomes unnecessary after the underlayer process.

In this instance, if there is a reaction product formed by the transformation of the resist film, this reaction product can also be removed at the same time that the unnecessary resist film is removed, thereby increasing throughput and reducing the cost. For example, in the above-mentioned underlayer process, if the thin film as the underlayer is subjected to dry etching, a reaction product is formed. It is therefore possible to remove concurrently the resist film itself that is used for masking the underlayer during the dry etching, and the reaction product formed by transformation of the resist film.

Besides the case that a reaction product derived from a resist and a resist itself are removed from a substrate, the present invention is also applicable to the case that an organic matter not derived from a resist (e.g., fine contaminant derived from the human body) is removed from a substrate with a removal liquid for the organic matter.

In the foregoing preferred embodiment, it is so configured as to establish interlock by the controller 19, namely, interlock by software. Without limiting to this, interlock may be established by hardware with the use of electric circuit.

Further, although in the foregoing preferred embodiment it is configured to perform the final drying process in the drying unit 91, the drying unit 91 is not essential. In an alternative, a pressure reducing function may be added to a rotational process unit 51 so that the final drying process is executed in this unit 51. In other alternative, when washing process with deionized water is executed in the rotational process unit 51, the inside of the chamber 65 may be made into a dark room. That is, the substrate processing apparatus of the present invention is an apparatus for removing an organic matter, such as polymer, with use of a removal liquid, which is configured such that a process chamber for performing removal process is made into a dark room at least during the time that such an organic matter is removed with the removal liquid.

### Second Preferred Embodiment

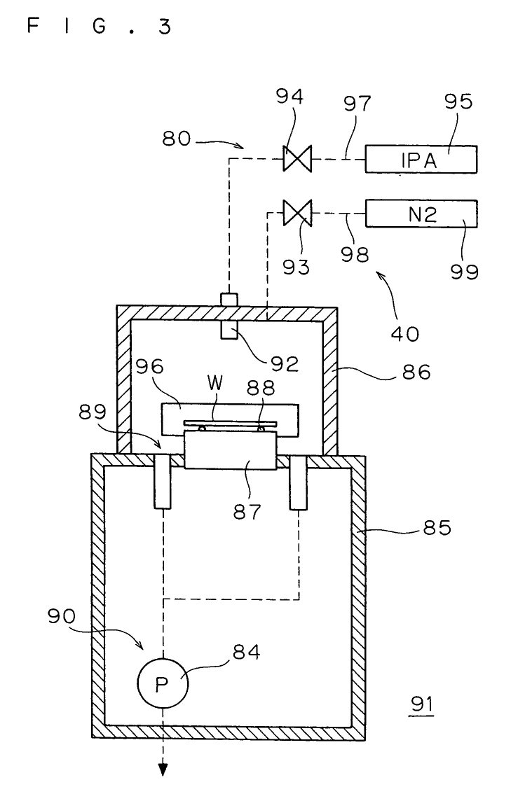

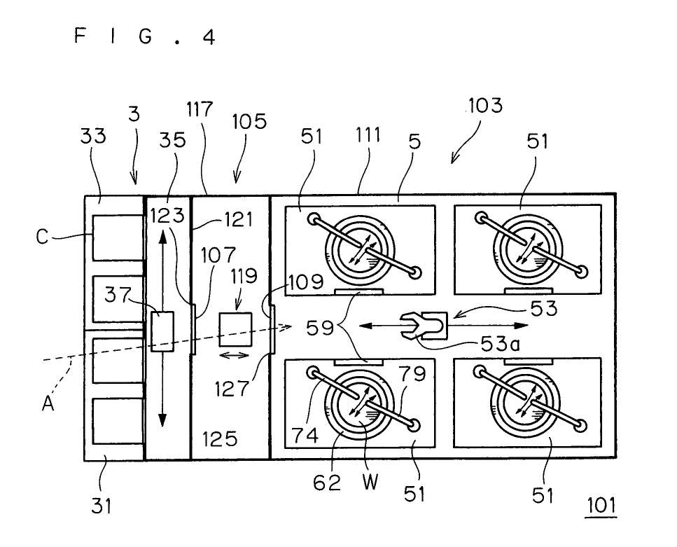

FIG. 4 is a diagram illustrating a planer configuration of a substrate processing apparatus according to a second preferred embodiment of the present invention. FIG. 5 is a diagram illustrating a vertically sectional configuration of the substrate processing apparatus in FIG. 4. A substrate processing apparatus 101 of the second preferred embodiment is substantially different from the substrate processing apparatus 1 of the first preferred embodiment in the following four points, but others are approximately the same. Similar parts have the same reference numerals and their description will be omitted here.

The substantially different points are: (i) a relay section 105 is disposed between an indexer section 3 and a process section 103 that houses a rotational process section 5 and drying process section 9; (ii) shutters 107 and 109 are disposed at opposite sides of the relay section 105; (iii) a drying process section 9 is disposed on the upper side of the rotational process section 5, and an interface 7 is omitted; and (iv) the configuration of the drying process section 9 is changed. Note that in the second preferred embodiment, the above-mentioned transfer table 39 in the indexer section 3 is omitted and its function is accomplished by a substrate transfer mechanism 119 of the relay section 105, which is described later.

In the substrate processing apparatus 101, a cassette allowing at least partially for the transmission of light is used as a carrier C. For example, there is used a FOUP (front opening unified pod) cassette having high transparency. The shutters 107 and 109 prevent light passing through the carrier C of high transparency to a substrate transport path for the substrate processing apparatus 101 from passing through the transport path to a process section 103, as indicated by arrow ‘A’ in FIG. 4. The inside of the process section 103 is a light-blocking area for blocking any light entering from the exterior.

Referring to FIGS. 4 and 5, the process section 103 includes, in a housing 111 to perform light blocking of the inside of the process section 103, the above-mentioned four rotational process units 51, the above-mentioned substrate transport mechanism 53, four drying units 113, and a plurality of (for example, two) temperature control units 115. Like the first preferred embodiment, two rotational process units 51 are disposed on each of the opposite sides of the substrate transport mechanism 53. Two drying units 113 stacking one upon another are disposed on the left and right sides, with the substrate transport mechanism 53 interposed therebetween, in an area on the rear side when viewed from the relay section 105 on the upper side of the rotational process unit 51. Two temperature control units 115 are disposed separately on the left and right sides, with the substrate transport mechanism 53 interposed therebetween, in an area on the front side when viewed from the relay section 105 on the upper side of the rotational process unit 51. Note that the number and location of the rotational process units 51, drying units 113 and temperature control units 115 which are disposed in the process section 103 are not limited to the configuration shown in FIGS. 4 and 5, and it is possible to employ a variety of configurations.

The configuration, function and operation of the rotational process unit 51 are the same as in the first preferred embodiment. The substrate transport mechanism 53 has the same configuration as that in the first preferred embodiment, except that it transfers a substrate W between the process section 103 and relay section 105, and transports a substrate W between the individual units 51, 113 and 115.

The drying unit 113 is used to dry a substrate W after being subjected to polymer removal process by the rotational process unit 51, and includes in its chamber a temperature control plate 113a with temperature control mechanism. The temperature control plate 113a elevates the temperature of the substrate W that is set on the temperature control plate 113a by the substrate transport mechanism 53, in order to evaporate and dry water and the like attached to the substrate W. The drying unit 113 may be replaced with the above-mentioned drying unit 91 of the first preferred embodiment.

The temperature control unit 115 is used to perform temperature control (more specifically, cooling) of the substrate W after being subjected to the drying process by the drying unit 113, and includes in its chamber a temperature control plate 115a for temperature control. The temperature control plate 115a performs temperature control of the substrate W that is set on the temperature control plate 115a by the substrate transport mechanism 53.

The relay section 105 is disposed between the indexer section 3 and process section 103, as shown in FIG. 4, and it includes, in the housing 117 that performs light blocking of the inside of the relay section 105, the substrate transfer mechanism 119 to transfer a substrate W among the relay section 105, indexer section 3 and process section 103. The substrate transfer mechanism 119 will be fully described later.

An opening section (gate section) 123 through which a substrate W is loaded and unloaded is provided in a partition section 121 between the indexer section 3 and relay section 105, as shown in FIGS. 4 and 6. The opening section 123 is provided with a shutter 107 that blocks light passing through the opening section 123 to the inside of the relay section 105. Closing the opening section 123 by the shutter 107 enables to block light passing through the opening section 123 to the inside of the relay section 105, so that the inside of the relay section 105 is made into a dark room.

An opening section (gate section) 127 through which a substrate W is loaded and unloaded is provided in a partition section 125 between the relay section 105 and process section 103, as shown in FIGS. 4 and 6. The opening section 127 is provided with a shutter 109 that blocks light passing through the opening section 127 to the inside of the process section 103. Closing the opening section 127 by the shutter 109 enables to block light passing through the opening section 127 to the inside of the process section 103, so that the inside of the process section 103 is made into a dark room.

The distance between the opening sections 123 and 127 is set to be greater than the width in the direction of transportation of a substrate W, so that the shutters 107 and 109 close the opening sections 123 and 127, respectively, with a substrate W mounted on the substrate transfer mechanism 119 of the relay section 105 described later. In the second preferred embodiment, it is possible to maintain the process section 103 in a dark room by maintaining the state of closing at least one of the opening sections 123 and 127 by the shutter 107 and 109, respectively.

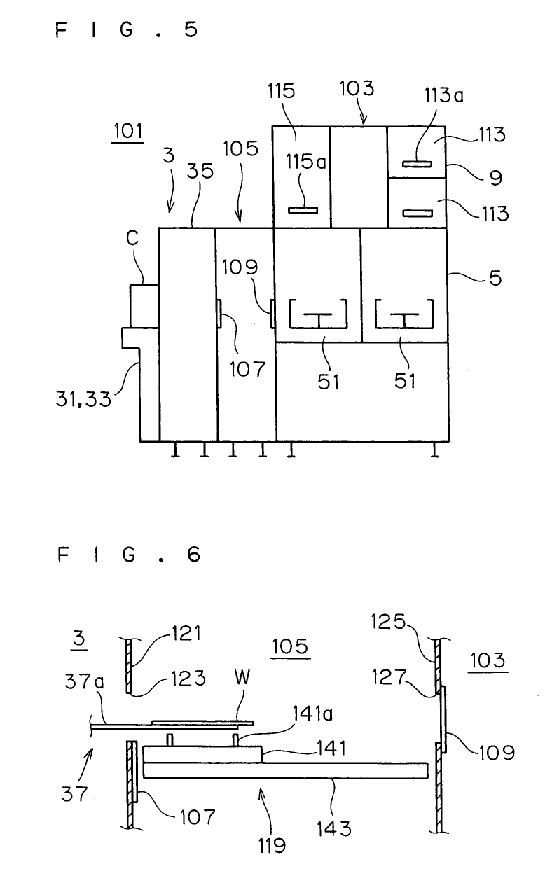

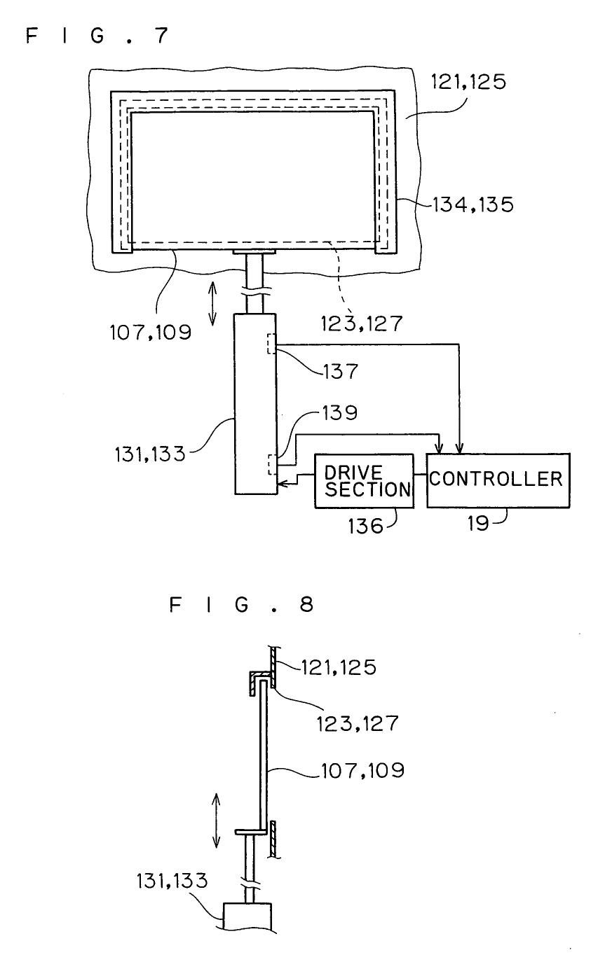

Referring to FIGS. 7 and 8, air cylinders 131 and 133 that are shutter opening and closing mechanisms drive the shutters 107 and 109 to move up an down to thereby open and close the opening sections 123 and 127. Holding sections 134 and 135, which hold the right and left edge parts of the shutters 107 and 109, and also hold the upper edge parts of the shutters 107 and 109 in their close position, are disposed in the right and left outer edge parts and the upper edge parts of the opening sections 123 and 127. The holding sections 134 and 135 hold the shutters 107 and 109 such that they can move up and down, and also reliably prevent light entering from the surroundings of the opening sections 123 and 127 when they are closed.

The air cylinders 131 and 133 are driven with a driving air supplied from a drive section 136 that is controlled by the controller 19. The controller 19 drives via the drive section 136 the air cylinders 131 and 133 so as to open and close the shutters 107 and 109. The air cylinders 131 and 133 are provided with detecting switches (for example, photomicrosensors) 137 and 139 in order to detect that the shutters 107 and 109 are in their close position (elevated position) or open position (lowered position). Depending on signals from the detecting switches 137 and 139, the controller 19 detects whether the shutter 107 is in its close position or open position.

Referring to FIGS. 6 and 9, the substrate transfer mechanism 119 of the relay section 105 includes a slide table 141 and drive mechanism 143 for driving the slide table 141. The drive mechanism 143 drives the slide table 141 to reciprocate between a first transfer position (position shown in FIG. 6) in the vicinity of the inside of the opening section 123 on the side of the indexer section 3 in the relay section 105, and a second transfer position (position shown in FIG. 9) in the vicinity of the inside of the opening section 127 on the side of the process section 103. The controller 19 controls via the drive mechanism 143 the slide table 141. Although in the second preferred embodiment the second transfer position of the slide table 141 is set to the vicinity of the inside of the opening section 127 in the relay section 105, it may be configured such that part of or the entire slide table 141 enters the process section 103 through the opening section 127. In this case, the transfer of a substrate W between the slide table 141 and substrate transport mechanism 53 is executed at the position through which part of or the entire slide table 141 enters the process section 103 (i.e., the second transfer position).

The slide table 141 is provided with a plurality of pins to hold the substrate W (for example, edge hold pins to hold the edge of a substrate W) 141a. Since the FOUP cassette is employed as a carrier C in the second preferred embodiment, an indexer arm 37a of an indexer mechanism 37 (see FIG. 6) is shaped so as to correspond to the configuration of a standardized FOUP cassette. For this, the configuration such as arrangement of the pins 141a of the slide table 141 is also so configured as not to interfere with the arm 37a when transferring a substrate W.

The following is the operation of the substrate processing apparatus 101 and, in particular, the operation of transferring a substrate W through the relay section 105, and the operation of opening and closing the shutters 107 and 109.

When a substrate W is transferred from the indexer mechanism 3 to the process section 103, first, the slide table 141 is located at the first transfer position, as shown in FIG. 6, and the opening section 123 is opened by the shutter 107 in the state that the opening section 127 is closed by the shutter 109. Subsequently, the substrate W taken out of the carrier C by the indexer arm 37a of the indexer mechanism 37 is then transferred to the slide table 141 of the substrate transfer mechanism 119 via the opening section 123. This transfer is accomplished by the action that the indexer arm 37a mounts the substrate W on the pins 141a of the slide table 141.

Referring to FIG. 9, after the opening section 123 is closed by the shutter 107, the opening section 127 is opened by the shutter 109 and the slide table 141 is moved from the first transfer position to the second transfer position, and the substrate W on the slide table 141 is received by a transport arm 53a of the substrate transport mechanism 53 through the opening section 127. After the substrate W is taken in the process section 103 by the transport arm 53a, the shutter 109 closes the opening section 127.

The substrate W taken in the process section 103 is then sent into the rotational process unit 51 by the substrate transport mechanism 53, and polymer removal process similar to that is the first preferred embodiment is performed in the rotational process unit 51. At the termination of the polymer removal process, the substrate W is taken out of the rotational process unit 51 and then sent into the drying unit 113 by the substrate transport mechanism 53. The temperature control plate 113a of the drying unit 113 elevates the temperature of the substrate W in order to evaporate and dry water attached thereto. At the termination of the drying process, the substrate W is taken out of the drying unit 113 and then sent into the temperature control unit 115 by the substrate transport mechanism 53. Then, the temperature control plate 115a of the temperature control unit 115 performs temperature control process. At the termination of the temperature control process, the substrate W is sent out of the process section 103 by the substrate transport mechanism 53.

When the substrate W is transported from the process section 103 to the indexer mechanism 3, first, the slide table 141 is located at the second transfer position, as shown in FIG. 9, and the opening section 127 is opened by the shutter 109 in the state that the opening section 123 is closed by the shutter 107. By the transport arm 53a of the substrate transport mechanism 53, the substrate W is mounted on the slide table 141 of the substrate transfer mechanism 119 and transferred through the opening section 127.

Subsequently, as shown in FIG. 6, after the shutter 109 closes the opening section 127, the opening section 123 is opened by the shutter 107 and the slide table 141 is moved from the second transfer position to the first transfer position. The substrate W on the slide table 141 is then received by the indexer arm 37a of the indexer mechanism 37 through the opening section 123. When the substrate W is taken in the indexer section 3 by the indexer arm 37a, the shutter 107 closes the opening section 123. The received substrate W is housed in the carrier C by the indexer mechanism 37.

Thus, according to the second preferred embodiment, the relay section 105 is disposed between the process section 103 and indexer section 3, and the shutter 107 is provided in the opening section 123 that is a gate section between the indexer section 3 and relay section 105, and the shutter 109 is provided in the opening section 127 that is a gate section between the relay section 105 and process section 103. Therefore, in the course of transporting the substrate W between the carrier C and process section 103, by controlling the opening and closing of the shutters 107 and 109 such that at least one of them is always in its close state, the inside of the process section 103 and the chamber 65 of the rotational process unit 51 can reliably be made into a dark room, thus preventing any adverse effect caused by light acting as a catalyst in the chamber 65.

With this configuration, if an FOUP cassette of high transparency is used as a carrier C, as in the second preferred embodiment, it is possible to reliably prevent the light passing through the FOUP cassette into the transport path for substrate W in the apparatus 101 from entering the process section 103 through the transport path.

By the presence of the shutters 107 and 109, it is possible to reliably perform light blocking of the inside of the process section 103 during replacement of carriers C.

Since the inside of the process section 103 housing the rotational process unit 51 can be made into a dark room, when a substrate W is transported from the rotational process unit 51 performing polymer removal process to the drying unit 113 performing drying process, even if a removal liquid for removing polymer is attached to the substrate W, it is avoidable that the removal liquid attached to the substrate W causes adverse effect due to light acting as a catalyst.

In addition, air flow between the indexer section 3 and relay section 105 and that between the relay section 105 and process section 103 are avoidable by closing the opening sections 123 and 127 by the shutters 107 and 109, respectively.

As a modification of the second preferred embodiment, the following configuration is considerable. That is, since light blocking of the inside of the process section 103 is ensured by the shutters 107 and 109, the shutter 59 of the rotational process unit 51 may be omitted if there is no problem in the points of processing liquid scattering during polymer removal process and atmospheric control in the unit 51, etc.

As other modification, when no light block is required in areas other than the chamber 65 of the rotational process unit 51 in the process section 103, the shutter 107 may be omitted so that the remaining shutters 59 and 109 perform light block in the inside of the chamber 65. Also in this case, the shutters 59 and 109 are so controlled as not to open concurrently. Alternatively, when the shutter 109 is omitted instead of the shutter 107, the same effect is obtainable by the remaining shutters 59 and 107.

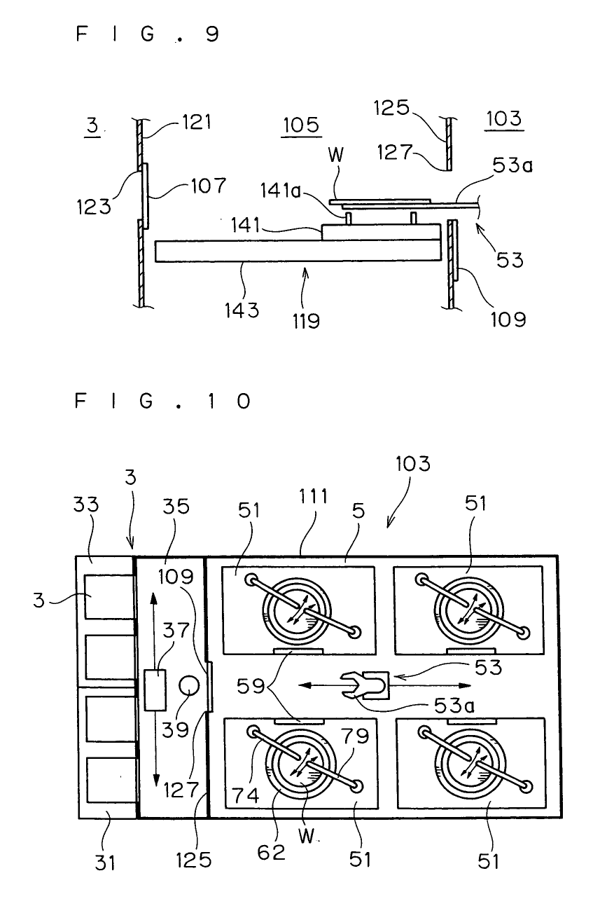

As still other modification, as shown in FIG. 10, the relay section 105 is omitted, and the transfer table 39 is added to the indexer section 3. A shutter 109 similar to that of the second preferred embodiment is provided in the opening section (gate section) 127 that is disposed in the partition section 125 between the indexer section 3 and process section 103. The shutter 109 and the shutter 59 of the chamber 65 may ensure the light blocking of the inside of the chamber 65. Also in this case, the shutters 59 and 109 are so controlled as not to open concurrently.

While the invention has been shown and described in detail, the foregoing description is in all aspects illustrative and not restrictive. It is therefore understood that numerous modifications and variations can be devised without departing from the scope of the invention.

What is claimed is:

1. A substrate processing apparatus that removes an organic matter from a substrate with use of a removal liquid, comprising:
a process chamber directed to an organic matter removal process;
a holding element to hold a substrate in said process chamber;
a removal liquid supply element to supply said removal liquid to said substrate held by said holding element; and
a light-blocking element disposed in a transport area for said substrate that extends from a cassette to said process chamber, thereby blocking light passing through said transport area into said process chamber, said cassette housing said substrate and allowing at least partially for the transmission of light.

2. The substrate processing apparatus according to claim 1 wherein
an optically-closed area enclosing said process chamber is defined in said substrate processing apparatus, and
said light-blocking element blocks light passing through said transport area into said optically-closed area.

3. The substrate processing apparatus according to claim 1 wherein
said light-blocking element includes a plurality of light-blocking sections that are arranged in a plurality of locations in said transport area, respectively, and are capable of blocking light passing through said transport area into said process chamber, and
the clearance between said plurality of light-blocking sections is greater than the size of said substrate in the direction of transport of said substrate.

4. The substrate processing apparatus according to claim 2 wherein
said light-blocking element includes a plurality of light-blocking sections that are arranged in a plurality of locations in said transport area, respectively, and are capable of blocking light passing through said transport area into said process chamber, and
the clearance between said plurality of light-blocking sections is greater than the size of said substrate in the direction of transport of said substrate.

5. The substrate processing apparatus according to claim 1 wherein
said process chamber includes a transfer opening to allow for the passage of said substrate, and
said light-blocking element includes a light-blocking section to block light passing through said transfer opening into said process chamber.

6. The substrate processing apparatus according to claim 2 wherein
said light-blocking area encloses:
a first process chamber serving as said process chamber directed to said organic matter removal process;
a second process chamber directed to a process different from said organic matter removal process; and
a substrate transport mechanism to transport said substrate between said first and second process chamber.

7. The substrate processing apparatus according to claim 1 wherein
said process chamber is housed in a predetermined process section,
a first opening to allow for the passage of said substrate is formed in said process section, and a second opening to allow for the passage of said substrate is formed in said process chamber, and
said light-blocking element includes:
a first light-blocking section disposed in said first opening to thereby block light passing through said first opening into said process section; and
a second light-blocking section disposed in said second opening to thereby block light passing through said second opening into said process chamber.

8. The substrate processing apparatus according to claim 1 wherein
said light-blocking element includes an openable shutter.

9. A substrate processing apparatus that removes an organic matter from a substrate with use of a removal liquid, comprising:
a process section to define a light-blocking area enclosing a process chamber directed to an organic matter removal process;
a holding element to hold a substrate in said process chamber;
a removal liquid supply element to supply said removal liquid to said substrate held by said holding element;
an indexer section including an indexer mechanism to load and unload said substrate with respect to a carrier set at a predetermined position;
a relay section disposed between said indexer section and said process section; and
a light-blocking element that is disposed in a transport area for said substrate extending from said carrier to said process section, thereby blocking light passing through said transport area into said process section,
wherein
said relay section includes a transfer mechanism to transfer said substrate between said indexer section and said process section,
a first gate section to allow for the passage of said substrate is disposed between said indexer section and said relay section,
a second gate section to allow for the passage of said substrate is disposed between said relay section and said process section,
said light-blocking element includes:
a first light-blocking section disposed in said first gate section to thereby block light passing through said first gate section into said relay section; and
a second light-blocking section disposed in said second gate section to thereby block light passing through said second gate section into said process section.

10. The substrate processing apparatus according to claim 9 wherein
said carrier is a cassette allowing at least partially for the transmission of light.

11. The substrate processing apparatus according to claim 9 wherein
said process section comprises:
a first process chamber serving as said process chamber;
a second process chamber to perform a process different from said organic matter removal process; and
a substrate transport mechanism to transport said substrate between said first and second process chamber.

12. The substrate processing apparatus according to claim 11 wherein
in said second process chamber there is performed drying process of said substrate after being subjected to organic matter removal in said first process chamber.

13. A substrate processing apparatus that removes an organic matter from a substrate with use of a removal liquid, comprising:
a process section enclosing a process chamber directed to an organic matter removal process;
a holding element to hold a substrate in said process chamber;
a removal liquid supply element to supply said removal liquid to said substrate held by said holding element;
an indexer section including an indexer mechanism to load and unload said substrate with respect to a carrier set at a predetermined position;
a relay section disposed between said indexer section and said process section; and
a light-blocking element that is disposed in a transport area for said substrate extending from said carrier to said process chamber to thereby block light passing through said transport area into said process chamber,
wherein
said relay section includes a transfer mechanism to transfer said substrate between said indexer section and said process section,
said light-blocking element includes:
a first light-blocking section that is located between said indexer section and said relay section and provided in a gate section allowing for the passage of said substrate, thereby blocking light passing through said gate section into said relay section; and
a second light-blocking section that is disposed in said process chamber and provided in an opening allowing for the passage of said substrate, thereby blocking light passing through said opening into said process chamber.

14. The substrate processing apparatus according to claim 9 wherein
said first and second light-blocking sections include openable first and second shutters, respectively, and
said first and second shutters are so controlled as not to open concurrently.

15. The substrate processing apparatus according to claim 1 wherein
a viewing window for viewing the inside of said process chamber is provided on the wall of said process chamber.

16. The substrate processing apparatus according to claim 15 wherein
an illumination element is provided in the inside of said process chamber, and
said illumination element is brought into its active state of executing illumination when said viewing window is opened, and said illumination element is brought into its inactive state of not executing illumination when said viewing window is closed.

17. The substrate processing apparatus according to claim 16 further comprising:
a window-open prohibiting element to prohibit the opening of said viewing window at least during a period of time that said substrate is processed with said removal liquid.

18. The substrate processing apparatus according to claim 16 further comprising:
a removal-liquid-supply prohibiting element to prohibit the supply of said removal liquid from said removal liquid supply element at least during a period of time that said viewing window is opened.

19. The substrate processing apparatus according to claim 1 wherein
said organic matter to be removed from said substrate is a reaction product caused by the transformation of a resist film formed on said substrate.

20. The substrate processing apparatus according to claim 19 wherein
said reaction product is polymer that is formed by performing dry etching of a thin film present on the surface of said substrate with use of said resist film serving as a mask.
